(19) United States
(12) Patent Application Publication
(10) Pub. No.: US 2013/0191254 A1
(43) Pub. Date: Jul. 25, 2013

(54) ACCOUNT DATA DISPLAY USING AN INDUCTIVE SIGNAL INTERFACE

(71) Applicant: Andreas Klintberg, Bromma (SE)

(72) Inventor: Andreas Klintberg, Bromma (SE)

(21) Appl. No.: 13/356,891

(22) Filed: Jan. 24, 2012

(51) Int. Cl. G06Q 40/00

(52) U.S. Cl. 705/30

(57) ABSTRACT

Illustrated is a system and method for an inductive signal interface used inductively receive electrical power and account data from a mobile computing device, the account data to include an account limit and an account balance. The system and method may also include a battery to store the electrical power. The system and method to use a processor to be powered by the battery and to identify an indication value, the indication value as a difference between the account limit and account balance. The system and method may also use a balance display to display the indication value as a remainder indication.

### CROSS REFERENCE TO RELATED APPLICATIONS

This application is related to U.S. patent application Ser. No. 12/478,766, titled “Inductive Signal Transfer System for Computing Devices” filed on Jun. 4, 2009 and to U.S. patent application Ser. Nos. 12/628,401 and 12/841,001, filed Dec. 1, 2009 and Jun. 21, 2010 respectively both of which are titled “Power Bridge Circuit for Bi-Directional Wireless Power Transmission”. All three of the aforementioned patent applications are hereby incorporated herein by reference in their entirety.

### BACKGROUND

A credit card is a small plastic card issued to users as a system of payment. It allows its holder to buy goods and services based on the holder's promise to pay for these goods and services. The issuer of the card creates a revolving account and grants a line of credit to the consumer (or the user) from which the user can borrow money for payment to a merchant or as a cash advance to the user. Credit cards are issued by a credit card issuer, such as a bank or credit union, after an account has been approved by the credit provider, after which cardholders can use it to make purchases at merchants accepting that card. The card is associated with the account. This account typically has a limit on the total monetary value of the goods and services that can be charged against the account.

### BRIEF DESCRIPTION OF THE DRAWINGS

Some embodiments of the invention are described, by way of example, with respect to the following figures:

FIG. 1 is a diagram of a card, according to an example embodiment, capable of being charged inductively and receiving and displaying account data as a series of bars.

FIG. 2 is a diagram of a card, according to an example embodiment, capable of being charged inductively and receiving and displaying a remainder indication for account data.

FIG. 3 is a diagram of a card, according to an example embodiment, capable of being charged inductively and receiving and displaying account data as a series of wedges.

FIG. 4 is a diagram of a card, according to an example embodiment, capable of being charged inductively and receiving and displaying a remainder indication for account data displayed as a series of wedges.

FIG. 5 is a diagram of a card, according to an example embodiment, capable of being charged inductively and receiving and displaying account data as an animation.

FIG. 6 is a diagram of the card, according to an example embodiment, capable of being charged inductively and receiving and displaying a remainder indication at different positions in an animation.

FIG. 7 is a diagram of a card, according to an example embodiment, capable of being charged inductively and receiving and displaying account data as an animation.

FIG. 8 is a diagram of the card, according to an example embodiment, capable of being charged inductively and receiving and displaying a remainder indication changing form in an animation.

FIG. 9 is a diagram of a system, according to an example embodiment, for updating and displaying account data on a credit card using inductive power and data transfer provided by a mobile computing device.

FIG. 10 is a block diagram of a card, according to an example embodiment, capable of updating and displaying account data using inductive power and data transfer provided by a mobile computing device.

FIG. 11 is a block diagram of an apparatus, according to an example embodiment, used to update and display account data using inductive power and data transfer provided by a mobile computing device.

FIG. 12 is a block diagram of a system, according to an example embodiment, used to update and display account data using inductive power and data transfer provided by a mobile computing device.

FIG. 13 is a flow chart illustrating a method, according to an example embodiment, executed to update and display account data using inductive power and data transfer provided by a mobile computing device.

FIG. 14 is a flow chart illustrating the execution of a method, according to an example embodiment, that when executed updates and displays account data using inductive power and data transfer provided by a mobile computing device.

FIG. 15 is a tri-stream from chart illustrating the execution of the decision operation, according to an example embodiment, used to determine whether a change in an account balance has occurred.

FIG. 16 is a flow chart illustrating an execution of an operation, according to an example embodiment, executed to assign the difference to a remainder indication value.

FIG. 17 is a flow chart illustrating an execution of an operation, according to an example embodiment, executed to display a final remainder indication value as the remainder indication.

FIG. 18 is a flow chart illustrating an execution of an operation, according to an example embodiment, executed to initiate inductive charging.

### DETAILED DESCRIPTION

Illustrated is a system and method for updating and displaying account data on a credit card using inductive power and data transfer provided by a mobile computing device. An account, as used herein, is a financial account (e.g., revolving credits account, savings account, and checking account) associated with the card. Account data is data relating to the account, including, for example, an account limit, account remainder (e.g., a “remainder indication value”) and an account balance. A remainder indication, as used herein, is at least one pixel position on a display used to show the remaining balance of an account. The use of inductive power and data transfer is described in U.S. patent application Ser. Nos. 12/478,766, 12/628,401 and 12/841,001, all of which are incorporated by reference in their entirety herein.

In one example embodiment, a card is paired with a mobile computing device using inductive charging and data transfer. Once paired, the card is charged and an updated remainder indication value generated. The remainder indication value is displayed on the card as part of the balance display. The mobile computing device provides connectivity for the card to access account data residing on a server. Connectivity may be a logical or physical connection. The server may be operated by a card issuer, payment processor, or other suitable party.

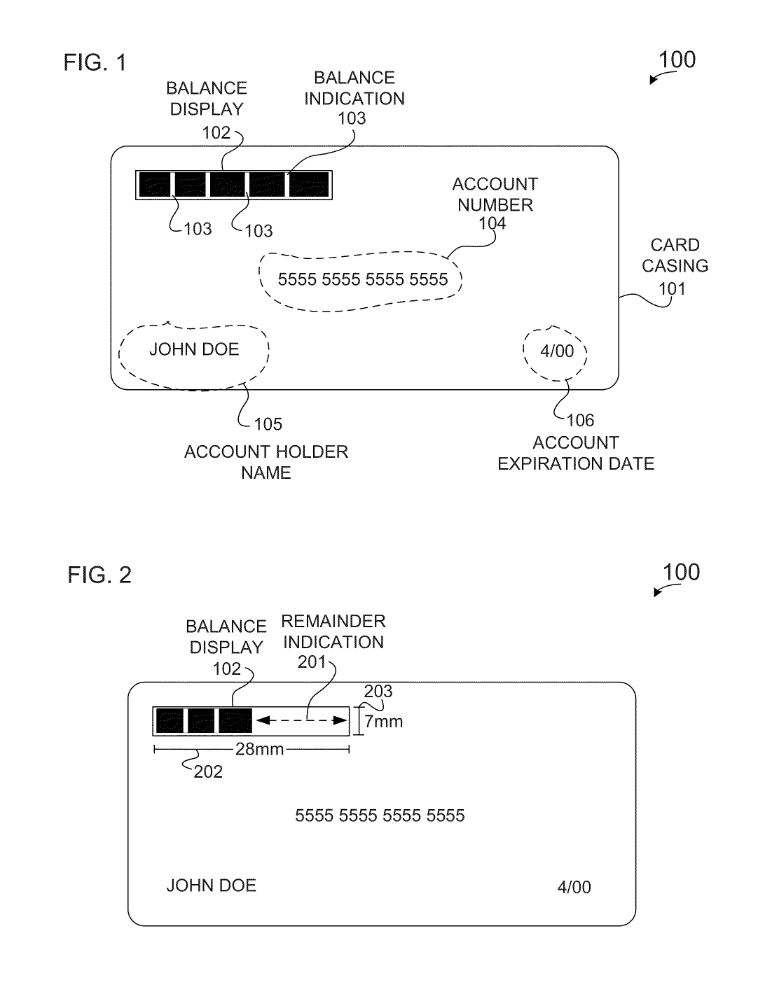

FIG. 1 is a diagram of an example card 100 capable of being charged inductively and receiving and displaying account data as a series of bars. Shown is a card casing 101. The dimensions of this card casing 101 may be 85.60×53.98 mm in size, with a thickness of 0.76 mm. The card casing 101 may be made of plastic, such as polyvinyl chloride, acrylonitrile butadiene styrene, or polycarbonate. Further, the card casing 101 may include a magnetic strip (not shown) visible on the surface of the card casing 101. Displayed on the surface of the card casing 101 is a balance display 102, and balance indication 103. Each balance indication 103 is a bar. The balance display 102 can be structured from, for example, glass, plastic, thin-film or composite material. The balance display 102 may use one of the following to render and display account data: a liquid crystal display (LCD) screen, an active matrix liquid crystal display (AMLCD), a thin-film transistor liquid crystal display (TFT-LCD), an organic light emitting diode (OLED), an Active-matrix OLED (AMOLED), an interferometric modulator display (IMOD), or other suitable display device. In an embodiment, the display displays color images. The balance indication 103 sub-divides the balance display 102, with each balance indication 103 representing a percentage of the account limit associated with the account. Also shown is an account number 104, which is a numeric value to uniquely identify the account. Further, an account holder name 105 is show which is the proper name under which the account is opened with the credit card issuer. Also shown is an account expiration date 106 that denotes the time at which the account is no longer valid.

FIG. 2 is a diagram of an example card 100 capable of being charged inductively and receiving and displaying a remainder indication for account data. Shown is a remainder indication 201 that illustrates the remaining balance of an account. This remaining balance is credit or cash that is usable by the account holder for purchases of goods and services. In one embodiment the balance display 102 may have a height of 7 mm and a length of 28 mm. These dimensions are denoted at 203 and 202 respectively.

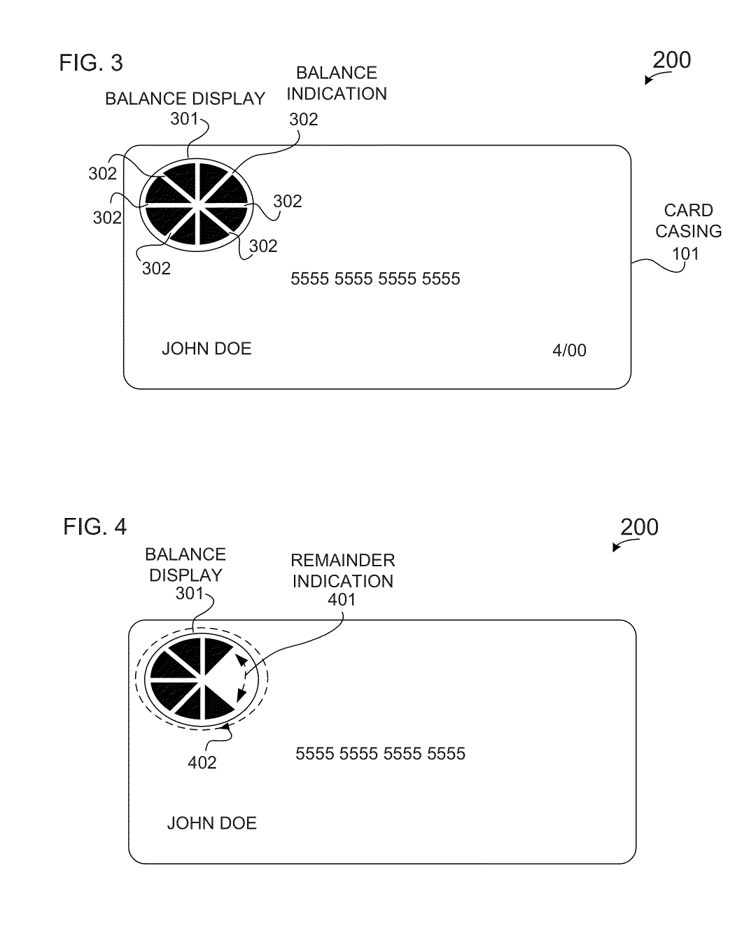

FIG. 3 is a diagram of an example card 200 capable of being charged inductively and receiving and displaying account data as a series of wedges. Shown is a card 200 with a balance display 301. This balance display 301 includes a series of balance indication 302 each of which is in the shape of a wedge. The balance display 301 can be structured from, for example, glass, plastic, thin-film or composite material. The balance display 301 may use one of the following to render and display account data: a liquid crystal display (LCD) screen, an active matrix liquid crystal display (AMLCD), a thin-film transistor liquid crystal display (TFT-LCD), an organic light emitting diode (OLED), an Active-matrix OLED (AMOLED), an interferometric modulator display (IMOD), or other suitable display device. In an embodiment, the display displays color images. The balance indication 301 sub-divides the balance display 301, with each balance indication 302 representing a percentage of the account limit associated with the account.

FIG. 4 is a diagram of an example card 100 capable of being charged inductively and receiving and displaying a remainder indication for account data displayed as a series of wedges. Shown is a remainder indication 401 that illustrates the remaining balance of an account. This remaining balance is credit or cash that is usable by the account holder for purchases of goods and services. In one embodiment the balance display 102 may have a circumference of 35 mm, as denoted 402.

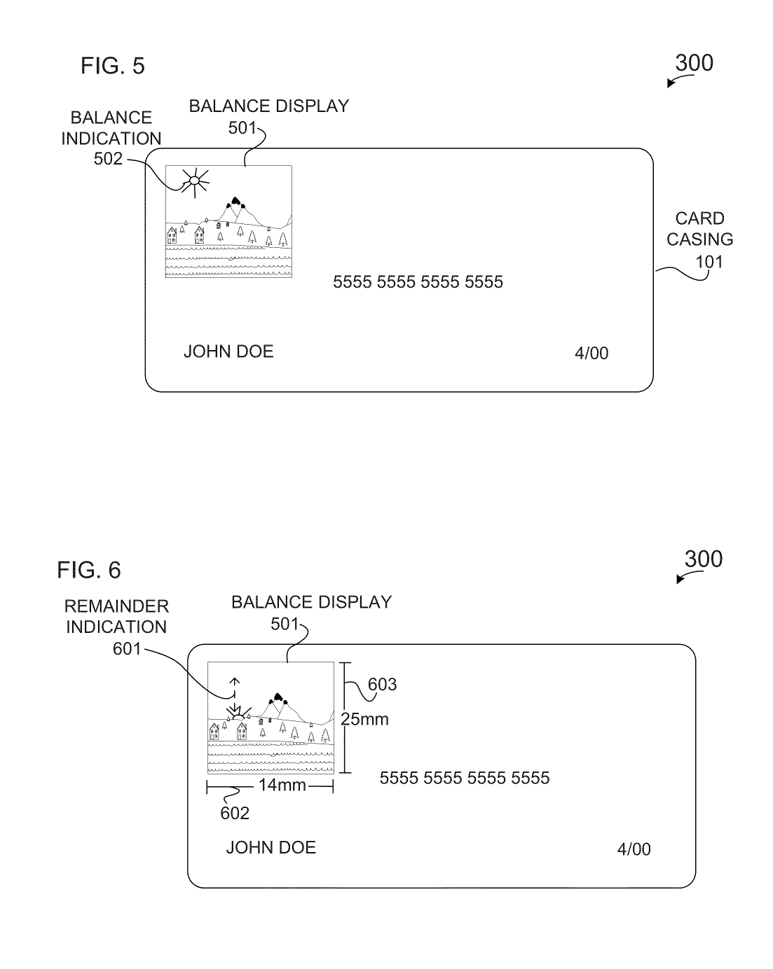

FIG. 5 is a diagram of an example card 300 capable of being charged inductively and receiving and displaying account data as an animation. Shown is a card 300 with a balance display 501. This balance display 501 includes a remainder indication 502 in the form of an animation that changes in relation to changes in an account balance. The balance display 501 can be structured from, for example, glass, plastic, thin-film or composite material. The balance display 501 may use one of the following to render and display account data: a liquid crystal display (LCD) screen, an active matrix liquid crystal display (AMLCD), a thin-film transistor liquid crystal display (TFT-LCD), an organic light emitting diode (OLED), an Active-matrix OLED (AMOLED), an interferometric modulator display (IMOD), or other suitable display device. In an embodiment, the display displays color images. The balance indication 501 changes to corresponding changes in an account balance. For example, as an account balance increases, the remainder indication 502 may be displayed in a difference position in the animation. The animation itself may be series of individual frames, each of which displays the remainder indication 502 in a different position on the balance display 501. Frames, as used herein, include a film frame formatted according to a codec such as the Motion Picture Experts Group (MPEG) codec.

FIG. 6 is a diagram of the example card 300 capable of being charged inductively and receiving and displaying a remainder indication at different positions in an animation. Shown is a remainder indication 601 that illustrates the remaining balance of an account as a figure in the animation. Here, for example, a sun is shown to set when the account limit is reached. Specifically, as the account limit is reached a first individual frame is replaced with a second individual frame, where each frame shows the sun at a different position representing a remainder indication 601. This remaining balance is credit or cash that is usable by the account holder for purchases of goods and services. In one embodiment the balance display 501 may have a height of 25 mm and a length of 14 mm. These dimensions are denoted at 603 and 602 respectively.

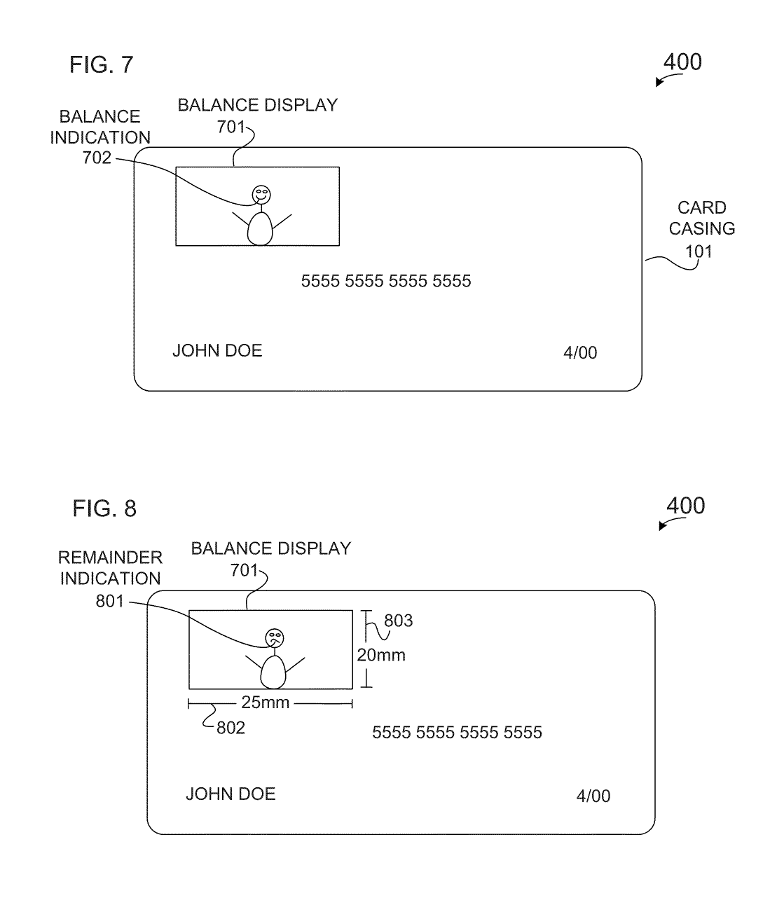

FIG. 7 is a diagram of an example card 400 capable of being charged inductively and receiving and displaying account data as an animation. Shown is a card 400 with a balance display 701. This balance display 701 includes a remainder indication 502 in the form of an animation that changes in relation to changes in an account balance. The balance display 701 can be structured from, for example, glass, plastic, thin-film or composite material. The balance display 501 may use one of the following to render and display account data: a liquid crystal display (LCD) screen, an active matrix liquid crystal display (AMLCD), a thin-film transistor liquid crystal display (TFT-LCD), an organic light emitting diode (OLED), an Active-matrix OLED (AMOLED), an interferometric modulator display (IMOD), or other suitable display device. In an embodiment, the display displays color images. The balance indication 701 changes to corresponding changes in an account balance. For example, as an account balance increases, the remainder indication 702 may change form in the animation. The animation itself may be series of individual frames, each of which displays the remainder indication 702 as a changed form within the balance display 701.

FIG. 8 is a diagram of the example card 400 capable of being charged inductively and receiving and displaying a remainder indication changing form in an animation. Shown is a remainder indication 801 that illustrates the remaining balance of an account as a figure in the animation. Here, for example, a face is shown to frown when the account limit is reached. Specifically, as the account limit is reached a first individual frame is replaced with a second individual frame, where each frame shows the face to have a different expression (e.g., smile, no expression, frown), each expression representing a remainder indication 601. This remaining balance is credit or cash that is usable by the account holder for purchases of goods and services. In one embodiment the balance display 701 may have a height of 20 mm and a length of 25 mm. These dimensions are denoted at 803 and 802 respectively.

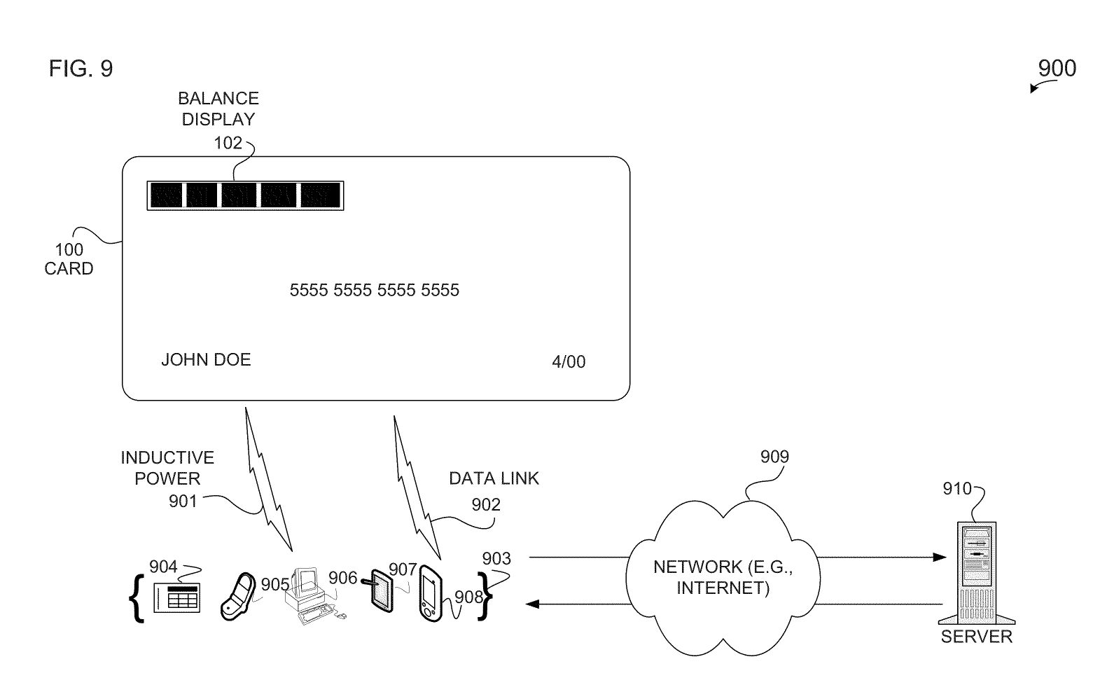

FIG. 9 is a diagram of an example system 900 for updating and displaying account data on a credit card using inductive power and data transfer provided by a mobile computing device. Shown is the card 100 that is provided electrical power and charged via inductive power 901. The use of the card 100 is merely for illustrative purposes and one or more of the cards 200-400 may be used instead of the card 100. The provided inductive power 901 is stored in a battery for future use. Also shown is the card 100 being provided account data via a data link 902. This account data may be displayed in the balance display 102. The inductive power 901 corresponds to a PWR_LNK and the data link 902 corresponds to a COMM_LNK both of which are enabled and described in U.S. patent application Ser. No. 12/841,001 at paragraphs 32-55. The inductive power 901 and 902 are provided by one of the mobile computing devices 903. These mobile computing devices 903 may be one of a card reader 904, cell phone 905, tablet 907, or smart phone 908. These mobile computing devices 903 may be operatively coupled to a server 910 via a network 909. The network 909 may be an internet, Local Area Network (LAN), Wide Area Network (WAN), or some other suitable network and associated topology. The network 909 may use any one of a number of protocols including those protocols (e.g., an Internet Protocol (IP)) associated with the Open Systems Interconnection model, a Global System of Mobile (GSM) communication system, a Code Division, Multiple Access (CDMA system), and a Universal Mobile Telecommunications System (UMTS), General Packet Radio Service (GPRS), third-generation (3G) mobile (or greater), High Speed Download Packet Access (HSDPA), High Speed Uplink Packet Access (HSUPA), Worldwide Interoperability for Microwave Access (WiMAX), Institute of Electrical and Electronics Engineers (IEEE) 802.11a-g, 802.15, or some other suitable protocol. The server 910 may be operated by a credit card issuer.

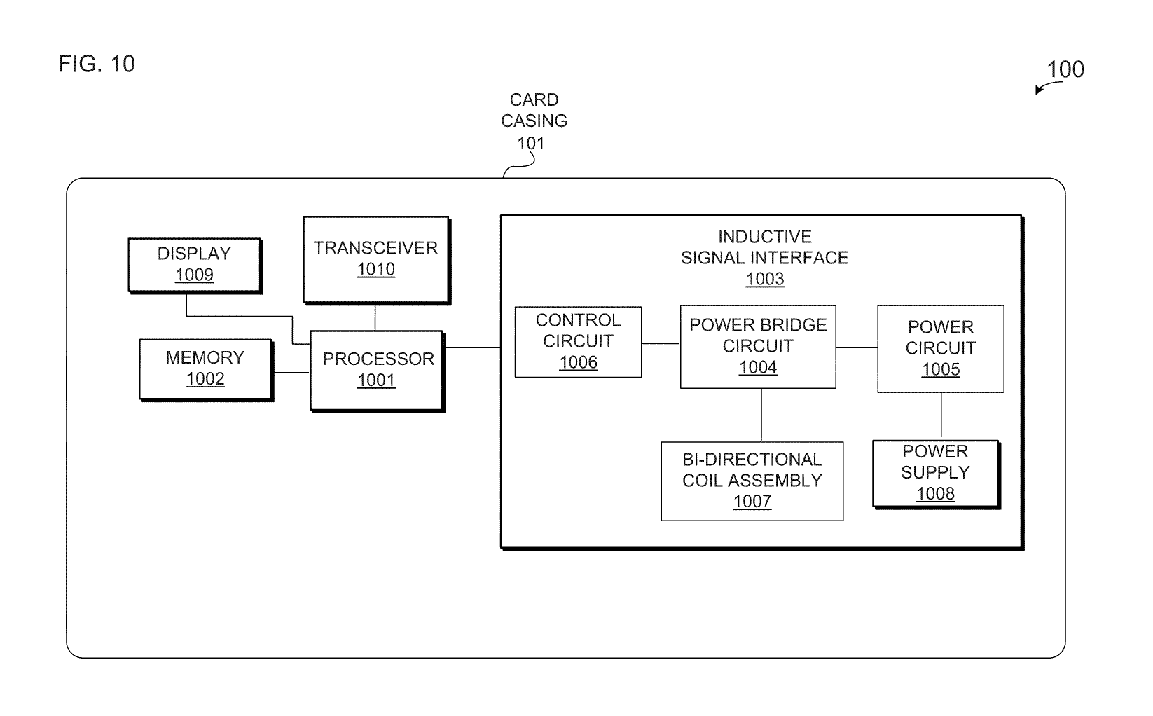

FIG. 10 is a block diagram of an example card 100 capable of updating and displaying account data using inductive power and data transfer provided by a mobile computing device. Illustrated are various blocks 1001-1010 that may be implemented in software, hardware, or firmware. Shown is the card 100 and card casing 101. The use of the card 100 is merely for illustrative purposes and one or more of the cards 200-400 may be used instead of the card 100. Residing inside of the card casing 101 are the various blocks 1001-1010. Illustrated is a processor 1001. In some example embodiments, the processor 1001 is an Integrated circuit such as an Application-Specific Integrated Circuit (ASIC) or Field-Programmable Gate Array (FPGA). Operatively coupled to the processor 1001 are a non-volatile memory 1002, display 1009, and optional transceiver 1010. The display 1009 provides power and data to the balance display 102. The optional transceiver 1010 sends and received account data via a protocol such as the Bluetooth, or some other suitable protocol. Also operatively coupled to the processor 1001 is an inductive signal interface 1003. The inductive signal interface 1003, and related technologies, are described in U.S. patent application Ser. Nos. 12/478,766, 12/628,401 and 12/841,001. For example, U.S. patent application Ser. No. 12/628,401 enabled and describes the inductive signal interface 1003 at paragraphs 34-40. The inductive signal interface 1003 includes a power bridge circuit 1004, a bi-directional coil assembly 1007, a control circuit 1006, and a power circuit 1005. Further, the inductive signal interface 1003 includes a power supply 1008 in the form of a battery that is charged via inductive power 901 received by the bi-directional coil assembly 1007. This power supply 1008 may be thin-film lithium ion battery, or other suitable battery. Additionally, the bi-directional coil assembly 1007 may be used to receive account data via the data link 902 and to provide this account data to the processor 1001 for storage in the memory 1002.

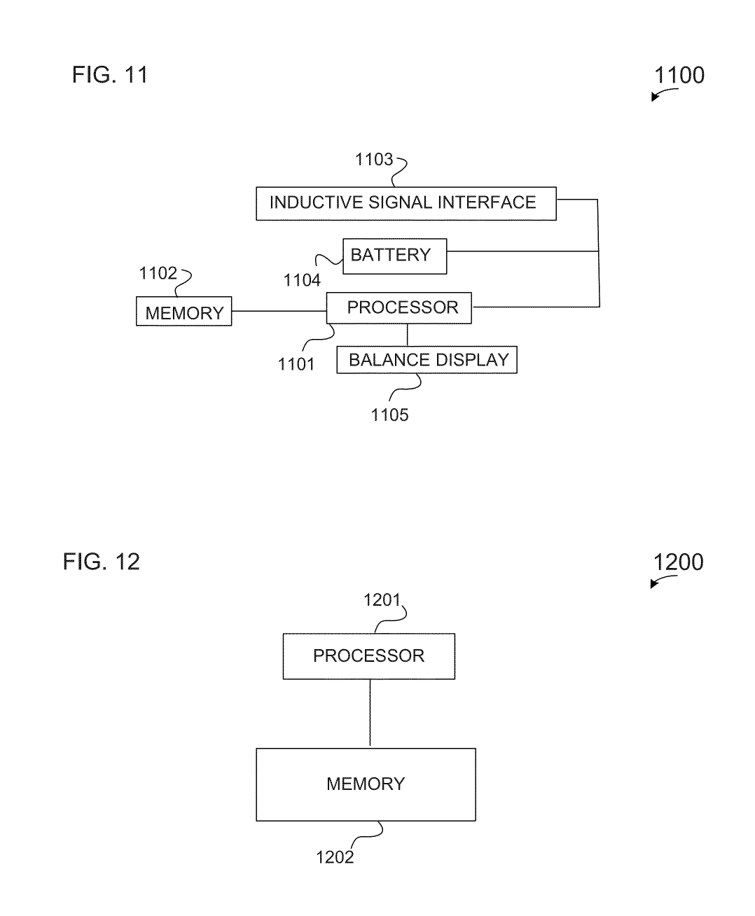

FIG. 11 is a block diagram of an example apparatus 1100 used to update and display account data using inductive power and data transfer provided by a mobile computing device. The various blocks shown herein may be implemented in software, hardware, or firmware. The cards 100-400 are examples of the apparatus 1100. Shown is a processor 1101 operatively connected to a memory 1102. Operatively coupled to the processors 1101 is an inductive signal interface 1103 used inductively receive electrical power and account data from a mobile computing device, the account data to include an account limit and an account balance. Operatively coupled to the processor 1101 is a battery 1104 to store the electrical power. In some example embodiments, processor 1101 is to be powered by the battery 1104. Further, when powered the processor 1101 is to identify an indication value, the indication value as a difference between the account limit and account balance. Operatively coupled to the processor 1101 is a balance display 1105 to display the indication value as a remainder indication. In some example embodiments, the apparatus is a card. In some example embodiments, the inductive signal interface 1103 includes a coil. The mobile computing device may be a smart phone. The balance display 1105 may be sub-divided into a series of wedges.

FIG. 12 is a block diagram of an example system 1200 used to update and display account data using inductive power and data transfer provided by a mobile computing device. Shown is a processor 1201 operatively connected to a memory 1202. The memory 1202 is in communication with the processor 1201, the memory 1202 including a computer-readable medium having instructions stored thereon for causing a suitably programmed computer to execute a method comprising receiving account data through an inductive signal interface, the account data to include an account limit and an account balance. The method further comprising identify an indication value, the indication value as a difference between the account limit and account balance. The method further comprising displaying a remainder indication where the account balance is less than the account limit. In some example embodiments, the remainder indication is a pixel position on a display used to show a remaining balance of an account. In some example embodiments, the pixel is used to render an animation. The method may also be executed to transmit a request for an account limit. Further, the method may also be executed to transmit a request for a current account balance.

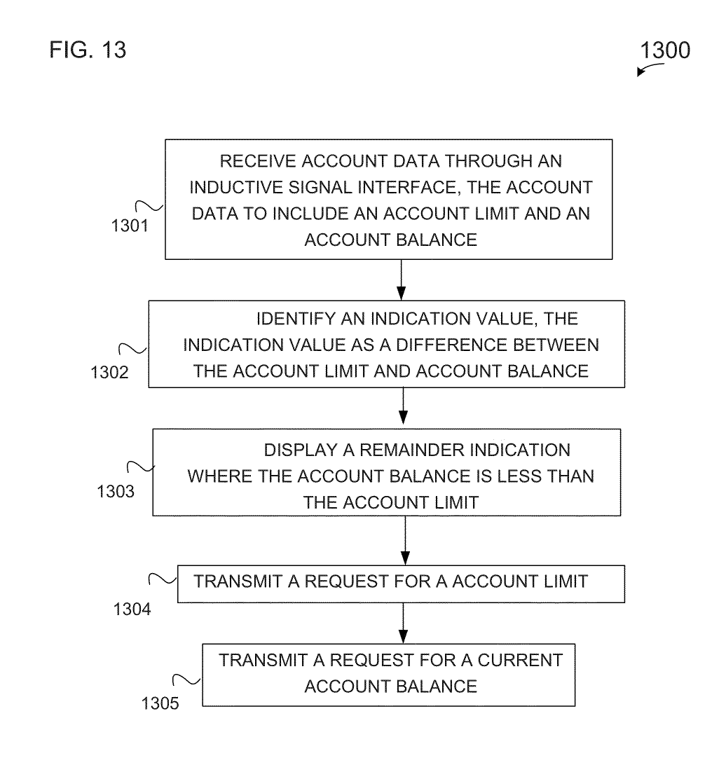

FIG. 13 is a flow chart illustrating an example method 1300 executed to update and display account data using inductive power and data transfer provided by a mobile computing device. The method 1300, and operations 1301-1305 included therein, may be executed on one or cards 100-400. Operation 1301 is executed to receive account data through an inductive signal interface, the account data to include an account limit and an account balance. Operation 1302 is executed to identify an indication value, the indication value as a difference between the account limit and account balance. Operation 1303 is executed to display a remainder indication where the account balance is less than the account limit. In some example embodiments, the remainder indication is a pixel position on a display used to show a remaining balance of an account. In some example embodiments, the pixel is used to render an animation. Operation 1304 is executed to transmit a request for an account limit. Operation 1305 is executed to transmit a request for a current account balance.

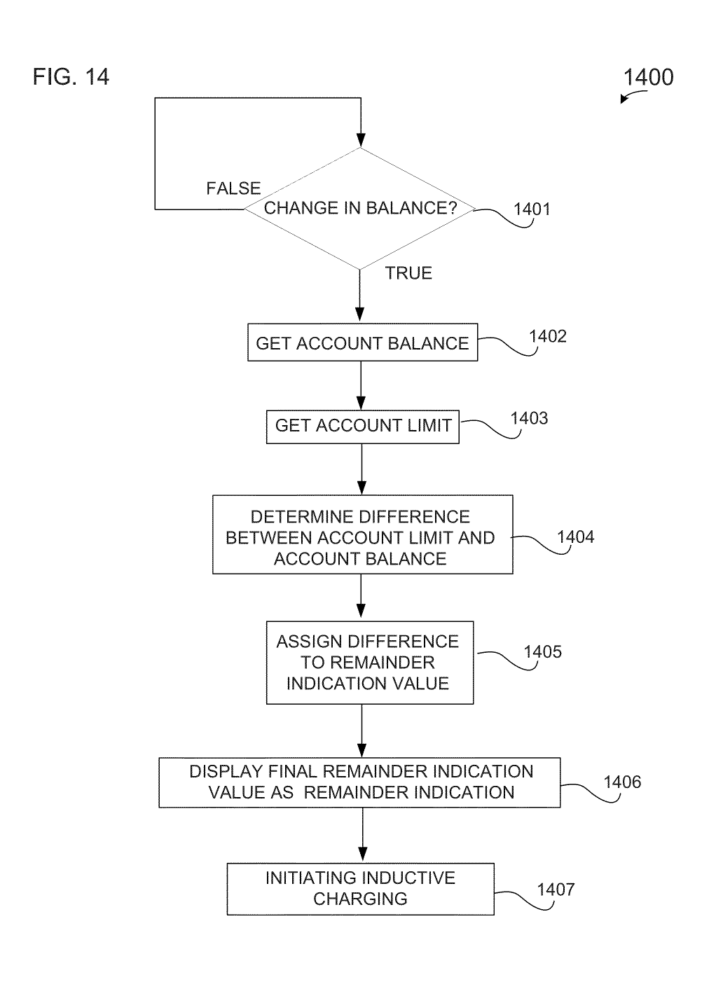

FIG. 14 is a flow chart illustrating the execution of the example method 1400 that when executed updates and displays account data using inductive power and data transfer provided by a mobile computing device. This method 1400 may be executed on one of the cards 100-400. Shown is a decision operation 1401 that is executed to determine whether a change in an account balance has occurred. In cases where the decision operation 1401 evaluates to “false”, the decision operation 1401 is re-executed. In cases where decision operation 1401 evaluates to “true”, an operation 1402 is executed. Operation 1402 is executed to get an account balance from the memory 1002. Operation 1403 is executed to get an account limit from memory 1002. Operation 1404 is executed to determine the difference between the account limit and the account balance. Operation 1405 is executed to assign the difference to a remainder indication value. Operation 1406 is executed to display a final remainder indication value as the remainder indication. Operation 1407 is executed to initiate inductive charging.

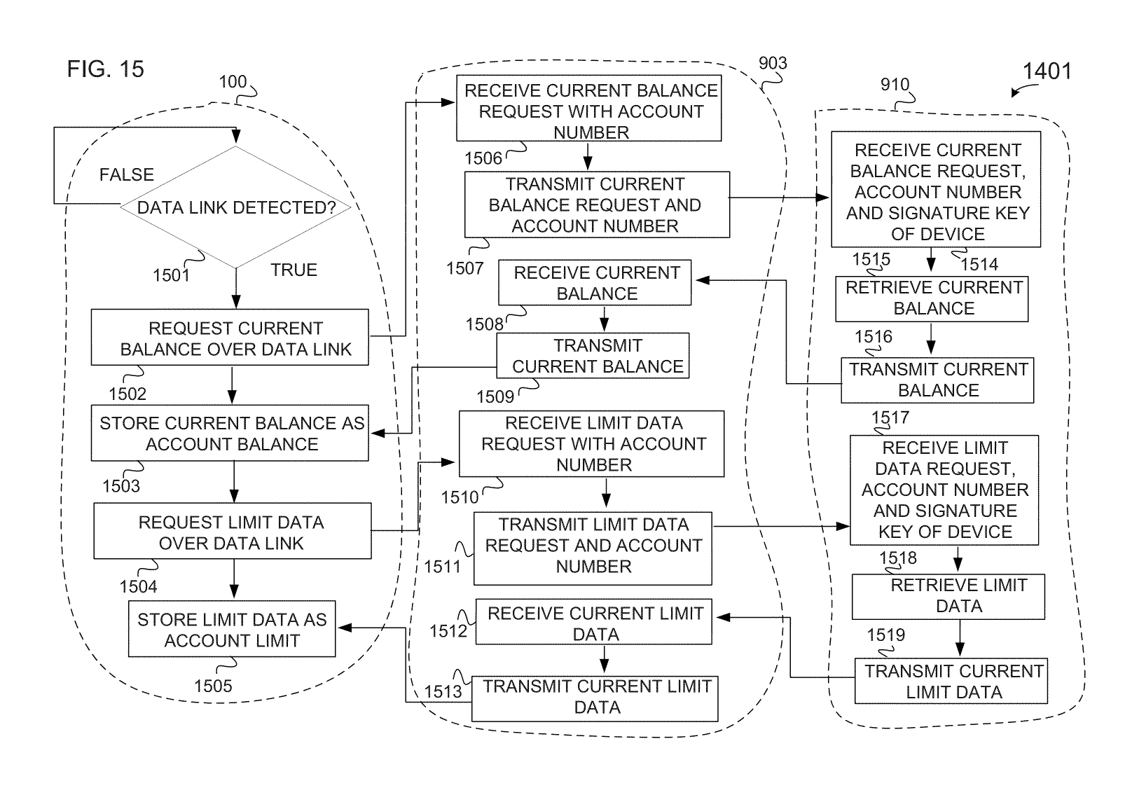

FIG. 15 is a tri-stream from chart illustrating the example execution of the decision operation 1401 used to determine whether a change in an account balance has occurred. Shown are operations 1501-1505 that are executed on the card 100. As noted elsewhere, the cards 200-400 may be used in lieu of the card 100. Also shown are operations 1506-1513 that are executed on one of the mobile computing devices 903. Further shown are operations 1514-1519 that are executed on the server 910. Decision operation 1501 is executed to determine whether a data link 902 has been detected. In cases where decision operation 1501 evaluates to “false”, the decision operation 1501 is re-executed. In cases where the decision operation 1501 evaluates to “true”, an operation 1502 is executed. Operation 1502 is executed to request a current balance for the account associated with the card 100, the request made over the data link 902. Operation 1506 is executed to receive the current balance request, the current balance request to include the account number 104. Operation 1507 is executed to transmit the current balance request and account number. This transmission may occur over the network 909. Operation 1514 is executed to receive the current balance request, account number and signature key of the mobile computing device 903. The signature key may be a numeric value generated using a symmetric or asymmetric encryption regime. Where the signature key is confirm as valid, and the mobile computing device 903 identified, operation 1515 is executed to retrieve the current balance. Operation 1516 is executed to transmit the current balance over the network 909. Operation 1508 is executed to receive this current balance. Operation 1509 is executed to transmit the current balance over the data link 902. Operation 1503 is executed to receive the current balance and store it as an account balance value. The account balance value to be stored into the memory 1002. Operation 1504 is executed to request limit data over the data link 902. Operation 1510 is executed to receive a limit data request with the account number 104. Operation 1511 is executed to transmit the limit data request and the account number 104 over the network 909. Operation 1517 is executed to receive a limit data request, account number 104 and a signature key for the mobile computing device 903. Operation 1518 is executed to retrieve the limit data. Operation 1518 may also be executed to confirm the validity of the signature key. In some example embodiments, operation 1518 may not confirm the validity of the signature key where the validity was previously performed at operation 1515. Operation 1519 is executed to transmit the current limit data along the network 909. Operation 1512 is executed to receive the current limit data. Operation 1513 is executed to transmit the current limit data. Operation 1505 is executed to receive and store the limit data as an account limit, the account limit to be stored into the memory 1002.

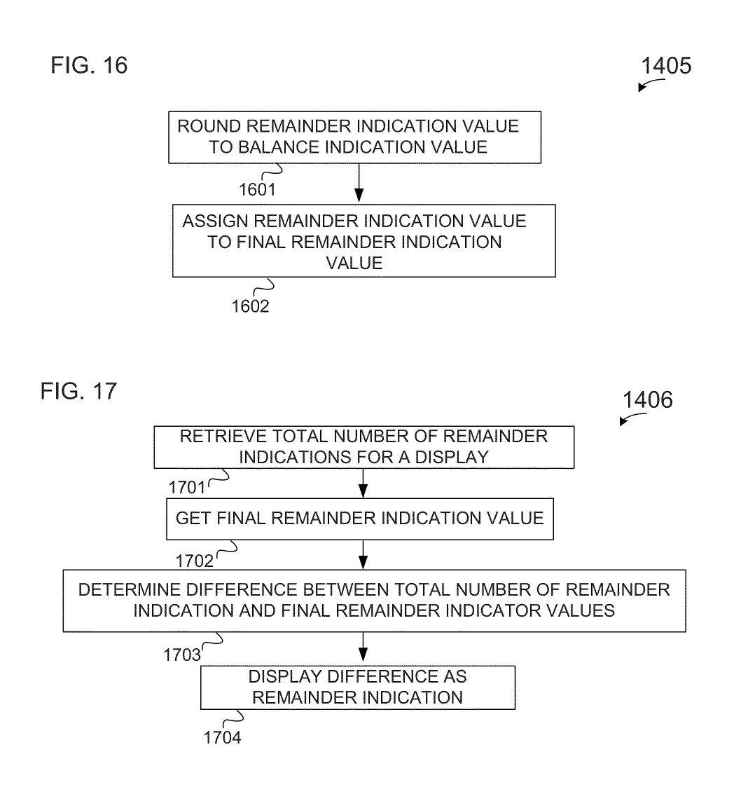

FIG. 16 is a flow chart illustrating an example execution of an operation 1405 executed to assign the difference to a remainder indication value. Shown is an operation 1601 that is executed to round the remainder indication value to a balance indication value. For example, the balance indication sub-divides the balance display into increments of 20% and the remainder indication value is 29% of the account limit remaining, then the remainder indication value will be rounded to 20% as opposed to 40%. Operation 1602 is executed to assign the remainder indication value to the final remainder indication value.

FIG. 17 is a flow chart illustrating an example execution of an operation 1406 executed to display a final remainder indication value as the remainder indication. Operation 1701 is executed to retrieve the total number of remainder indications for a display. Operation 1702 is executed to get a final remainder indication value. Operation 1703 is executed to determine the difference between total number of remainder indication and final remainder indication values. Operation 1704 is executed to display the difference as a remainder indication.

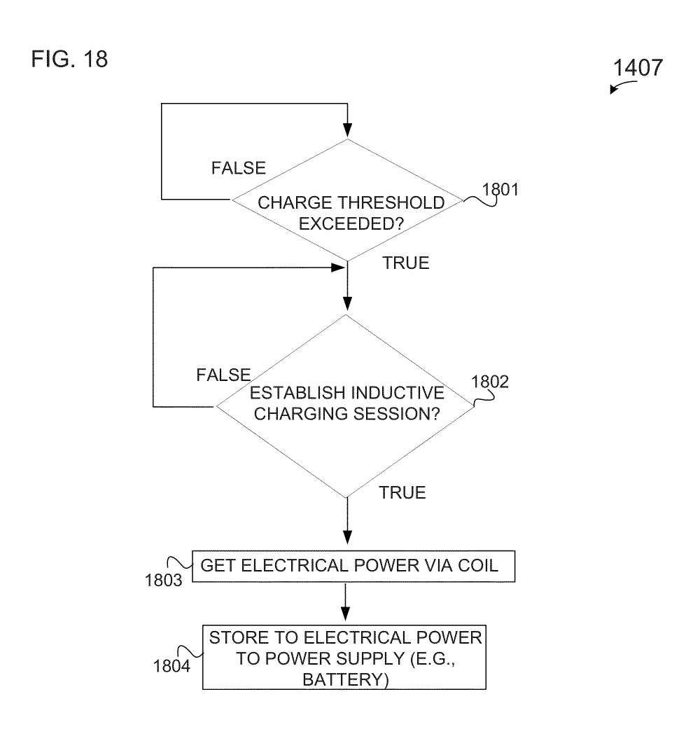

FIG. 18 is a flow chart illustrating an example execution of an operation 1407 executed to initiate inductive charging. Decision operation 1801 is executed to determine whether a charge threshold has been exceeded. In cases where decision operation 1801 evaluates to “false”, the decision operation 1801 is re-executed. In cases where the decision operation 1801 evaluates to “true”, a decision operation 1802 is executed. Decision operation 1802 is executed to determine whether an inducting charging session has been established. This inductive charging session denoted by the delivery of the inductive power 901 to the card 100. In cases where the decision operation 1802 evaluates to “false” the decision operation 1802 is re-executed. In cases where the decision operation 1802 evaluates to “true”, an operation 1803 is executed. Operation 1803 is executed to get electrical power via a coil such as the bi-directional coil assembly 1007. Operation 1804 is executed to store the electrical power to the power supply 1008.

While the machine-readable medium is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals, including optical and electromagnetic signals. The terms machine-readable medium or computer-readable medium shall be taken to be synonymous.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the “true” spirit and scope of the invention.

What is claimed is:

1. An apparatus comprising:
an inductive signal interface used inductively receive electrical power and account data from a mobile computing device, the account data to include an account limit and an account balance;
a battery to store the electrical power;
a processor to be powered by the battery and to identify an indication value, the indication value as a difference between the account limit and account balance; and
a balance display to display the indication value as a remainder indication.

2. The apparatus of claim 1, wherein the apparatus is a card.

3. The apparatus of claim 1, wherein the inductive signal interface includes a coil.

4. The apparatus of claim 1, wherein the mobile computing device is a smart phone.

5. The apparatus of claim 1, wherein the balance display is sub-divided into a series of wedges.

6. A method comprising:
receiving account data through an inductive signal interface, the account data to include an account limit and an account balance;
identifying an indication value, the indication value as a difference between the account limit and account balance; and
displaying a remainder indication where the account balance is less than the account limit.

7. The method of claim 6, wherein the remainder indication is a pixel position on a display used to show a remaining balance of an account.

8. The method of claim 7, wherein the pixel is used to render an animation.

9. The method of claim 6, further comprising transmitting a request for a account limit.

10. The method of claim 6, further comprising transmitting a request for a current account balance.

11. A non-transitory computer-readable medium having instructions stored thereon for causing a suitably programmed computer to execute a method comprising:
receiving account data through an inductive signal interface, the account data to include an account limit and an account balance;
identifying an indication value, the indication value as a difference between the account limit and account balance; and
displaying a remainder indication where the account balance is less than the account limit.

12. The method of claim 11, wherein the remainder indication is a pixel position on a display used to show a remaining balance of an account.

13. The method of claim 12, wherein the pixel is used to render an animation.

14. The method of claim 11, further comprising transmitting a request for an account limit.

15. The method of claim 11, further comprising transmitting a request for a current account balance.
